(19) United States
(12) Patent Application Publication
(10) Pub. No.: US 2023/0339644 A1
(43) Pub. Date: Oct. 26, 2023

(54) METHOD AND KIT FOR LABELLING OBJECTS

(71) Applicant: Gourgen AMBARTSOUMIAN, Laval (CA)

(72) Inventor: Gourgen AMBARTSOUMIAN, Laval (CA)

(21) Appl. No.: 18/005,695

(22) PCT Filed: Jul. 28, 2021
(86) PCT No.: PCT/CA2021/051058

§ 371 Date: Jan. 17, 2023

Related U.S. Application Data
(60) Provisional application No. 63/057,442, filed on Jul. 28, 2020.

(51) Int. Cl. B65C 9/26; B65C 1/02

(52) U.S. Cl. CPC B65C 9/262; B65C 1/021; B65C 2201/00

(57) ABSTRACT

A label has a support liner, a facestock adhered to a support liner by an adhesive layer on an under surface thereof, the label being magnetophilic or magnetic. The label is configured to have a magnetic connection force A resulting at least from magnetic attraction with an instrument. The label is configured to be releasably connectable to an end of the instrument by the connection force A, the connection force A between the label and the instrument being greater than an adhesion force B between said under surface of the label and the support liner, the connection force A between the label and the instrument being less than an adhesion force C between the under surface of the label and a target object at the moment of adhesion of the label on the target object, whereby the label is configured to be used with the instrument to transfer the label from the support liner to the target object by releasable connection of the label to the instrument.

### CROSS-REFERENCE TO RELATED APPLICATION

The present disclosure claims the priority of U.S. Patent Application No. 63/057,442, filed on Jul. 28, 2020 and incorporated by reference.

### TECHNICAL FIELD

The present application relates to labelling (a.k.a., labeling) of objects with labels, for instance in the field of biosciences and chemistry among others, such as when labelling vial caps and like small containers with small labels.

### BACKGROUND OF THE ART

Labels are commonly used to identify objects of all sorts. While labelling has been automated, there remains labelling activity requiring manual operations. When labelling small objects, e.g., in a range of millimeters or a few centimeters at most, it may be quite time-consuming for a person to label the objects. For instance, manipulating a small label, and then applying the small label to a small object, may require time in addition to good dexterity. There are numerous examples of such time-consuming manual labelling operations, such as the labelling of the vial caps or other small containers or objects, the labelling of electronic chip-boards and the like. In another example, the action of labelling containers with gloves on in laboratories may be challenging because the labels can stick to gloves and may then be difficult to remove. There are a multitude of fields in which small areas must be identified with small labels.

### SUMMARY

It is therefore an aim of the present disclosure to provide a method for labelling objects with a label that addresses issues related to the prior art.

It is another aim of the present disclosure to provide a kit for labelling objects with a label that addresses issues related to the prior art.

Therefore, in accordance with a first aspect of the present disclosure, there is provided a kit for labelling an object with a target label comprising: an instrument having at least one end for manipulating labels, and at least one label adhered to a support liner on an under surface, wherein the at least one label and the instrument have a magnetic connection force A resulting at least from magnetic attraction, wherein the at least one label is releasably connectable to the end of the instrument by the connection force A, the connection force A between the label and the instrument being greater than an adhesion force B between said under surface of the label and the support liner, the connection force A between the label and the instrument being less than an adhesion force C between the under surface of the label and a target object at the moment of adhesion of the label on the target object; whereby the instrument and label are used to transfer the label from the support liner to the target object by releasable connection of the label to the instrument.

Further in accordance with the first aspect, for instance, a plurality of the at least one label are on the support liner.

Still further in accordance with the first aspect, for instance, the at least one label is magnetophilic and the instrument includes a magnet.

Still further in accordance with the first aspect, for instance, the at least one label has at least an adhesive layer and a facestock.

Still further in accordance with the first aspect, for instance, the adhesive layer includes ferromagnetic particles.

Still further in accordance with the first aspect, for instance, the facestock includes ferromagnetic particles.

Still further in accordance with the first aspect, for instance, one or more of a top coat, a varnish and an ink on the facestock are provided.

Still further in accordance with the first aspect, for instance, the top coat, the varnish and/or the ink on the facestock include ferromagnetic particles therein.

Still further in accordance with the first aspect, for instance, the magnet in the instrument is a permanent magnet.

Still further in accordance with the first aspect, for instance, the magnet in the instrument is an electromagnet.

Still further in accordance with the first aspect, for instance, a switch may be on the instrument to actuate the electromagnet.

Still further in accordance with the first aspect, for instance, the at least one label is magnetic and the instrument is magnetophilic.

Still further in accordance with the first aspect, for instance, the at least one label has at least an adhesive layer and a facestock, the facestock including a flexible magnetic material.

Still further in accordance with the first aspect, for instance, at least one of the target object is provided, the target object being a container.

Still further in accordance with the first aspect, for instance, the target object is magnetic or magnetophilic.

Still further in accordance with the first aspect, for instance, an adhesive is at the at least one end of the instrument and contributes to the connection force A.

Still further in accordance with the first aspect, for instance, the adhesive at the at least one end is on a transfer label releasably adhered to the at least one end of the instrument.

Still further in accordance with the first aspect, for instance, the instrument has two ends configured for manipulating objects.

Still further in accordance with the first aspect, for instance, an adhesive of the under surface is an adhesive withstanding a temperature of −20C or below.

Still further in accordance with the first aspect, for instance, an adhesive of the under surface is an adhesive withstanding a temperature of −40C or below.

Still further in accordance with the first aspect, for instance, an adhesive of the under surface is a freezer grade adhesive withstanding a temperature of −65C or below.

Still further in accordance with the first aspect, for instance, an adhesive of the under surface is a cryogenic adhesive withstanding a temperature of −80C or below.

Still further in accordance with the first aspect, for instance, an adhesive of the under surface is a cryogenic adhesive withstanding a temperature of −196C or below.

Still further in accordance with the first aspect, for instance, an adhesive of the under surface is a cryogenic adhesive withstanding direct contact with liquid nitrogen.

Still further in accordance with the first aspect, for instance, an adhesive of the under surface is a cryogenic adhesive withstanding contact with vapor phase of liquid nitrogen in a dewar vessel.

Still further in accordance with the first aspect, for instance, an adhesive of the under surface is an adhesive withstanding contact with dry ice.

Still further in accordance with the first aspect, for instance, an adhesive of the under surface is an adhesive having frozen surface adherence capability at a surface temperature of 0C or below.

Still further in accordance with the first aspect, for instance, an adhesive of the under surface is an adhesive having frozen surface adherence capability at a surface temperature of −20C or below.

Still further in accordance with the first aspect, for instance, an adhesive of the under surface is an adhesive having frozen surface adherence capability at a surface temperature of −40C or below.

Still further in accordance with the first aspect, for instance, an adhesive of the under surface is an adhesive having frozen surface adherence capability at a surface temperature of −70C or below.

In accordance with a second aspect, there is provided a method for labelling an object comprising: applying an instrument against a label on a support liner, a connection force A resulting at least from magnetic attraction between the instrument and the label being greater than an adhesion force B between the label and the support liner; peeling the label from the support liner by distancing the instrument from the support liner with the label connected to the instrument; applying an end of the instrument with the label thereon against a target surface of the object, an adhesion force C between the label and the object being greater than said connection force A between the instrument and the label at the moment of adhesion of the label on the target object; and distancing the instrument from the object with the label adhering to the target surface of the object and detaching from the end of the instrument.

Further in accordance with the second aspect, for instance, actuating an electromagnet on the instrument is performed prior to applying the instrument against the label.

Still further in accordance with the second aspect, for instance, reducing an intensity of the electromagnet is performed before detaching the end of the instrument from the label.

Still further in accordance with the second aspect, for instance, reducing the intensity includes turning the electromagnet off.

Still further in accordance with the second aspect, for instance, an adhesive is put on the end of the instrument prior to applying the instrument against the label, the adhesive contributing to the connection force A.

Still further in accordance with the second aspect, for instance, putting the adhesive includes putting a transfer label on the end of the instrument.

Still further in accordance with the second aspect, for instance, applying the end of the instrument with the label thereon against the target surface of the object includes applying the label on a frozen surface of the object.

In accordance with a third aspect, there is provided a label comprising: a support liner; at least one facestock adhered to a support liner by an adhesive layer on an under surface thereof, the label being magnetophilic or magnetic; wherein the label is configured to have a magnetic connection force A resulting at least from magnetic attraction with an instrument, wherein the label is configured to be releasably connectable to an end of the instrument by the connection force A, the connection force A between the label and the instrument being greater than an adhesion force B between said under surface of the label and the support liner, the connection force A between the label and the instrument being less than an adhesion force C between the under surface of the label and a target object at the moment of adhesion of the label on the target object, whereby the label is configured to be used with the instrument to transfer the label from the support liner to the target object by releasable connection of the label to the instrument.

Further in accordance with the third aspect, for instance, the at least one label is magnetophilic and is configured to magnetically attract to a magnet of the instrument.

Still further in accordance with the third aspect, for instance, the adhesive layer includes ferromagnetic particles.

Still further in accordance with the third aspect, for instance, the facestock includes ferromagnetic particles.

Still further in accordance with the third aspect, for instance, one or more of a top coat, a varnish and an ink may be provided on the facestock.

Still further in accordance with the third aspect, for instance, the top coat, the varnish and/or the ink on the facestock include ferromagnetic particles therein.

Still further in accordance with the third aspect, for instance, the at least one label is magnetic and is configured to magnetically attract to a magnetophilic end of the instrument.

Still further in accordance with the third aspect, for instance, the facestock includes a flexible magnetic material.

Still further in accordance with the third aspect, for instance, the adhesive layer includes magnetic particles.

Still further in accordance with the third aspect, for instance, the facestock includes magnetic particles.

Still further in accordance with the third aspect, for instance, one or more of a top coat, a varnish and an ink may be on the facestock, the top coat, the varnish and/or the ink including magnetic particles.

Still further in accordance with the third aspect, for instance, the adhesive layer is an adhesive withstanding a temperature of −20C or below.

Still further in accordance with the third aspect, for instance, the adhesive layer is an adhesive withstanding a temperature of −40C or below.

Still further in accordance with the third aspect, for instance, the adhesive layer is a freezer grade adhesive withstanding a temperature of −65C or below.

Still further in accordance with the third aspect, for instance, the adhesive layer is a cryogenic adhesive withstanding a temperature of −80C or below.

Still further in accordance with the third aspect, for instance, the adhesive layer is a cryogenic adhesive withstanding a temperature of −196C or below.

Still further in accordance with the third aspect, for instance, the adhesive layer is an adhesive having frozen surface adherence capability at a surface temperature of 0C or below.

Still further in accordance with the third aspect, for instance, the adhesive layer is an adhesive having frozen surface adherence capability at a surface temperature of −20C or below.

Still further in accordance with the third aspect, for instance, the adhesive layer is an adhesive having frozen surface adherence capability at a surface temperature of −40C or below.

Still further in accordance with the third aspect, for instance, the adhesive layer is an adhesive having frozen surface adherence capability at a surface temperature of −70C or below.

The term “kit” in the present disclosure may mean providing or rendering available for purchase the combination of the components together or providing or rendering available for purchase any of the components separately which can be put together and used by a end user. Each of the components should be considered as the part of the kit which is covered by the present disclosure.

### DESCRIPTION OF THE DRAWINGS

FIGS. 1 to 6 are a sequence of steps of a method for labelling objects with labels, in which:

FIG. 1 is a schematic view of magnetic labels on a support liner relative to a transfer instrument;

FIG. 2 is a schematic view of the transfer instrument contacting a magnetic label with magnetic attraction;

FIG. 3 is a schematic view of the transfer instrument detaching the magnetic label from the support liner by magnetic attraction;

FIG. 4 is a schematic view of the transfer instrument approaching the magnetic label to a target surface of an object;

FIG. 5 is a schematic view of the transfer instrument pressing the magnetic label to the target surface of the object;

FIG. 6 is a schematic view of the transfer instrument separating from the magnetic label, with the magnetic label secured to the target surface of the object;

FIG. 7 is a perspective view of an exemplary embodiment of the transfer instrument; and

FIG. 8 is a perspective view of another exemplary embodiment of the transfer instrument.

### DETAILED DESCRIPTION

A method for labelling objects with labels in accordance with the present disclosure is shown in the sequence of FIGS. 1-6. The method of FIGS. 1-6 is conveniently practical when labelling objects with small labels (in a range of millimeters or a few centimeters at most), in particular when applying such small labels on small surfaces or small objects. In other types of applications the same method and technology may provide benefits when larger labels may be used. For example, the method and technology described herein may be used with labels that are 4″ wide, such as direct thermal labels or thermal-transfer barcode labels. With adequate magnetic and mechanical forces, the method and technology described herein may be used with labels being up to 6-8″ in dimension, if not more. Hence, although, the described application is well suited to be used for small size labels, the use of larger labels for larger containers using the described method is contemplated. A non-exhaustive list of fields and objects to which the method of the present disclosure may be beneficial is provided below. The method described herein is well suited to be performed manually, but may be automated and may be executed by robots or robotic equipment or in production line using an automated labeling equipment. The concepts of adhesion and adhesion force are used herein to describe the bond between the adhesives and the surfaces they contact. Other expressions for adhesion may include “tack”, “tackiness”, “stickiness”, “bond surface energy”, “bonding forces”, “adherence”, “peel adhesion value”, “cohesive strength”, “adhesion strength”, “work of adhesion”, etc. For simplicity, the expression “adhesion” is mostly used throughout. The adhesion parameters may for instance be measured by loop tack, and referred to as “adhesion force” according to ASTM (American Society for Testing and Materials).

Referring to FIG. 1, a plurality of magnetic or magnetophilic labels 10 are illustrated, as being on a support liner 12. The moniker “magnetic” in the expression magnetic label 10 implies that the label 10 may be magnetically attracted to, or may magnetically attract another component as described below. The magnetic label 10 may thus be magnetic, or may be attracted to an appropriate magnetic field, by having a ferromagnetic constituent or component. The term ferromagnetic in this disclosure also implies ferrimagnetic materials or substances. The moniker “magnetic” does not imply that the label 10 is necessarily a magnet or has a magnet. Another moniker to describe the label 10 is “magnetophilic”. For the purpose of the present disclosure, the moniker “magnet” or “magnetic” also implies ferro-magnetic substances having a high susceptibility to magnetization and which may persist after removal of the applied field and/or all other types of substances and materials that can create any type of magnetic field. The moniker “magnetophilic” means a material or a substance that can be attracted to a magnet or to a material through any type of magnetic force, and may include magnets, ferromagnetic materials or substances, ferrimagnetic materials or substances. However, for simplicity, the expression “magnetic label 10” will be used herein, in the sense described above, i.e., that it may be used as part of a set operating with magnetic attraction resulting from a magnetic field. The magnetic labels 10 may be on any appropriate backing format (a.k.a., liner, support liner or release liner), such as a sheet, roll, a single-label piece, etc. The magnetic labels 10 has various layers, such as a printable layer 10A that may be regarded as the facestock of the magnetic label 10 or a layer of ink applied over the magnetic or a magnetophilic surface, a facestock layer 10B that may or may not be magnetic or magnetophilic, and an adhesive layer 10C. Other layers may be present such as lamination(s), varnishes, top-coats, inks including thermochromic inks, piggy-back label, etc. For example, the layer 10A may also include magnetic or magnetophilic compound or particles, such as metallic particles mixed and applied with an ink, a varnish or a top-coating substance, while layer 10B may be a substrate. In another embodiment, a magnetophillic powder or particles can be mixed with the adhesive layer 10C facing the support liner 12, additionally or alternatively. Likewise, a magnetophillic powder or particles can be incorporated inside a facestock material during its extrusion or production. Stated differently, the magnetic label 10 also can be created by applying a coating or a lamination over any material, or by incorporating metallic, ferromagnetic or magnetic particles in the manufacturing of any of the layers, that will attribute magnetic or magnetophilic properties to the label 10. Thus, in an embodiment, there is a metallic or magnetophilic powder or particles incorporated inside the ink or the varnish applied over the label material (e.g. plastic, paper, polymer, cloth, foil, composite material, or any combination of materials) in the label 10. In an embodiment the magnetophilic powder includes iron nano micro particles (e.g. Fe₃O₄) for example in the range of 0-20 micrometers. In another embodiment the range of is 10-40 micrometers for such particles. In an embodiment, the facestock material is or includes a flexible magnet obtained through a facestock extrusion process or calendaring. Such flexible magnets are also known as “rubber magnets”. The magnetic label 10 can have any shape or configuration, such as circle, rectangle, square, triangle, polygon and any other symmetric or asymmetric or atypical shape. The magnetic label 10 can be printed or blank. Moreover, the magnetic label 10 may integrate one or more wireless communication tags or device of any type such as RFID or NFC tags.

The support liner 12 may have an integral coating or like release layer (e.g., a silicone, fluorosilicone, or wax among other examples of release coatings or release materials). Alternatively, the support liner 12 may have non-stick properties that may not require the presence of any additional adhesive release layer. The magnetic label 10 can be of any shape or can be in any format on the support liner 12, e.g. roll, sheet, fanfold, stripe, booklet, etc.

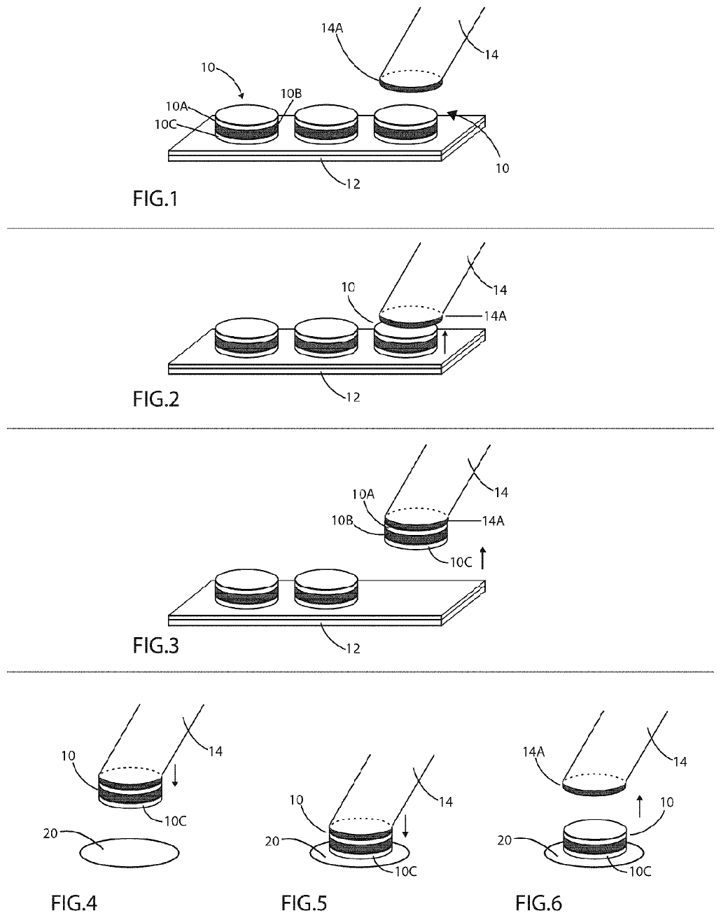

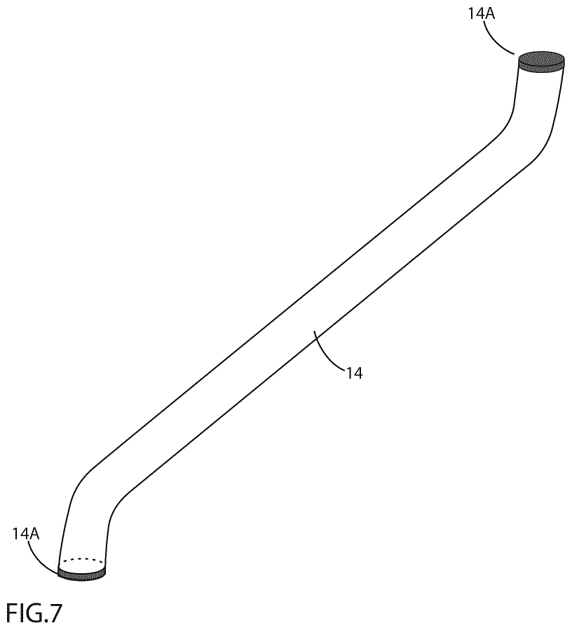

Referring to FIGS. 2, 3 and 7, a transfer instrument 14 is shown. The transfer instrument 14 may have any appropriate body shape so as to be manually handled by a user. The transfer instrument 14 is shown as being an elongated rod of circular cross-section, with one or more flat contact end surface 14A (two shown in FIG. 7), and a bend in the rod adjacent to the contact end surface 14A. According to other embodiments, the instrument 14 is a disposable rod with a permanent magnet or magnetophilic substance/material at its the end surface 14A, or even on opposed ends thereof. In another embodiment, the instrument 14 comprises magnetic ends that can be removed and replaced as needed. In an embodiment, the instrument 14 in at least one location may have a cross-section dimension/diameter between 0.2 inch and 0.5 inch. In another embodiment, the instrument 14 in at least one location may have a cross-section dimension/diameter between 0.3 inch and 0.75 inch. In another embodiment, the instrument 14 in at least one location may have a cross-section dimension/diameter between 0.5 inch and 1.5 inch. A cushioning pad or layers of coating or like material, such as a rubber sleeve, may be provided on the shaft of the transfer instrument 14, to facilitate manipulation of the transfer instrument 14 and/or enhance the ergonomic properties of the transfer instrument 14. In an embodiment, the instrument 14 may have an anti-magnetic layer or shield to diminish or eliminate the unnecessary magnetic filed created around the instrument 14 and keep it limited to the end 14A for picking the label 10.

In an embodiment, the transfer instrument 14 and, more particularly, its contact end surface 14A or parts of the transfer instrument 14 in proximity to the contact end surface 14A forms a magnetic-attraction pair with the magnetic labels 10, i.e., the label 10 and contact end surface 14A have magnetic attraction forces between them. In an embodiment, the contact end surface 14A is a permanent magnet. The permanent magnet may be integrated to the transfer instrument 14, i.e., the instrument 14 may be a magnet or magnetophilic in its entirety or have a magnet or magnetophilic material integrated at certain location(s) of the instrument 14, or a magnet or magnetophilic material may be attached, incorporated or glued to the contact end surface 14A of the transfer instrument 14. The magnetic labels 10 may incorporate the magnetic or magnetophilic layer 10B, and/or may have a magnetic or magnetophilic coating 10A, such as a ferrous or ferromagnetic material or a magnetic material so as to magnetically connect to the contact end surface 14A of the transfer instrument 14. In an embodiment, it is the transfer instrument 14 that has the magnetic material or that is the source of magnetic force, whereas the magnetic labels 10 have the magnetic or magnetophilic layer 10B, or like layer or particles of a ferrous material that will magnetically connect to the magnet at the tip of the transfer instrument 14. In an embodiment, both the magnetic labels 10 and transfer instrument 14 have magnets, that are arranged to have attracting poles facing each other. The transfer instrument 14 may be a permanent magnet such as natural or rare-earth magnet made from alloys of rare-earth elements, though it is considered to use of any other types magnets including but not limited to ferrite (a.k.a., ceramic magnet), neodymium, alnico, samarium cobalt, iron and/or other magnets or any combination thereof. The use of an electromagnet is also contemplated. In such a case, a dial or like control interface may be provided on the instrument 14 or for the instrument (e.g., Bluetooth® control with a smart device such as a phone or tablet), to adjust the magnetic field. For example, the electromagnet may vary the intensity of the magnetic field, with a greater intensity when detaching the label 10 from the support liner 12, and reduced intensity with the label 10 is applied to an object. The electromagnet solution is well suited to be used as part of an automated process. The connection force between the transfer instrument 14 and the magnetic labels 10 is greater than the adhesive force by which the magnetic labels 10 are against the support liner 12. As an embodiment the transfer instrument 14 may also have an air suction component onto it to provide additional force to facilitate the lifting of the label 10 from the release liner 12. As another possibility, the use of a removable adhesive label or of an adhesive on the contact end surface 14A of the transfer instrument 14, that will facilitate the release of the label 10 from the support liner 12 is contemplated, for instance as described in PCT patent application publication no. WO 2019/056130, the contents of which are incorporated herein by reference. Use of such a hybrid method with mechanical bonding and magnetic forces may result in a facilitated transfer of label 10.

The transfer instrument 14 is thus shaped as a stylus to be handled as a pen, but other geometries are contemplated (not just elongated), such as with a wider body, such as a paddle, with any appropriate cross-sections, including various polygonal sections—square, rectangle, triangle, hexagonal, octagonal, etc. or other symmetric or asymmetric or atypical sections. In an embodiment, the instrument 14 may have a combination of shapes such as a cylindrical shape body and a square, rectangular or any other polygon-shape tip or any other combination of shapes and configurations. In an embodiment, the transfer instrument 14 may have more than one tip of any shape or configuration (e.g., 14A). The transfer instrument 14 may have at least two distinct end shapes on the same unit designed to handle different sizes or shapes of labels. The transfer instrument 14 can be in any color or transparent and might be blank or printed with any graphic, image, logo, barcode, serial number or data. The transfer instrument 14 may comprise a punch, a hole, embossed area, drilled hole, a carve, groove, stamp (a design) or a relief or an attachment such as a metal ring to attach a hand-strip. The transfer instrument 14 may incorporate a battery operated or solar-rechargeable or light-rechargeable light or a digital device such as a clock/timer, electrical component, or a wireless communication tag or device such as RFID or NFC tag, or WIFI or Bluetooth capability. The contact end surface 14A is shown as being a flat or quasi-flat surface. However, other types of surfaces are possible, though flat is preferred for the contact of the magnetic label 10 to it, in the manner shown in FIGS. 2 and 3. Indeed, as shown in FIG. 2, the transfer instrument 14 is used to pick up an magnetic label 10. The transfer instrument 14 is approached, hovered over one of the labels 10 (FIG. 1), and pressed upon it or brought in close proximity for the label 10 to magnetically adhere to the contact end surface 14A. In another embodiment, the transfer instrument 14 is part of a robotic device or automation device that can pick and apply magnetic or magnetophillic labels 10 described herein.

Referring to FIG. 8, an embodiment of the transfer instrument 14 is shown, featuring an electromagnet 30 at a proximity to the content end surface 14A, and actuatable to emit a magnetic field. The transfer instrument may for example include a trigger button 31, associated with a power source, such as a battery 32 embedded in the transfer instrument, or separated therefrom, as shown at 33. The component 33 may be another type of power source as well. Moreover, while the transfer instrument 14 is shown having a trigger button 31 that may be a switch or a rheostat (though a rheostat may be distinct from the trigger button 31), any other type of user interface may be present if the transfer instrument 14 of FIG. 8 is used manually. For example, a foot pedal may be present. In an embodiment, the instrument 14 can be connected to a power source via a wire. In an another embodiment, the instrument 14 may be connected to a computer through a cable to a USB port or a similar type port or connection for recharging or powering.

The connection forces from the magnetic attraction between the label 10 and the contact end surface 14A is greater than the adhesion forces between the label 10 and the support liner 12, as the backing 12 is designed with a view to allow a release of the label 10. The diameter or a cross-section dimension of the contact end surface 14A (e.g., 0.05″-0.5″, 0.2″-1″, 0.4″-1.5″, or greater for instance if the label is larger) may be equal or greater than that of the label 10, so as not to have the label 10 exceed the perimeter of the contact end surface 14A. It is however contemplated to have the label 10 larger than the contact end surface 14A. Accordingly, this allows the detachment of the magnetic label 10 from the support liner 12, as shown in FIG. 3. After this operation, the magnetic label 10 is at the end of the transfer instrument 14, as in FIGS. 3 and 4, with its tacky surface exposed and leading the end of the transfer instrument 14.

The magnetic label 10 may then be applied to the object 20, which may be a vial just by way of example. The exposed tacky surface of the magnetic label 10 is positioned against the target surface of the object 20, and pressure is applied for the magnetic label 10 to adhere to the target surface of the object 20.

In an embodiment, the method of application may be regarded as having three or more steps: 1) peeling and lifting of the magnetic label 10 from the support liner 12 by a magnetic force and/or a combined magnetic force and mechanical force (e.g., from an adhesive force) exceeding the adhesion force; 2) placing the magnetic label 10 on a substrate or on an object 20, such as substrates with small or confined areas as a possibility; and 3) releasing the magnetic label 10 from the transfer instrument 14 due to an adhesion force exceeding the magnetic force. If the magnetic force is from an electromagnet 18, the releasing may include reducing an intensity of the magnetic field or stopping the magnetic force.

The method is based on the fact that the adhesion force of the magnetic label 10 to the target surface of the object 20 is stronger compared to the magnetic force or combined magnetic force and mechanical force between the magnetic label 10 and the transfer instrument 14. The difference in forces causes a detachment of the magnetic label 10 from the contact end surface 14A of the transfer instrument 14, and results in its transfer to the object 20. In another embodiment, the target surface may include a magnetic or magnetophilic surface itself which may facilitate the release of the adhesive label 10 from the surface of the transfer instrument 14.

Also, at the same time, the magnetic force or connection force of the magnetic label 10 to the transfer instrument 14 is stronger than the adhesion force of the adhesive of the magnetic label 10 to the support liner 12 which allows the magnetic label 10 to detach from the support liner 12.

As mentioned above, in order to achieve the relative adhesion properties described above, the adhesion parameters can be measured by loop tack, and peel adhesion according to ASTM (American Society for Testing and Materials), to ensure the above-described bonding forces are applied for the method to be adequately performed. The values will depend on the surface of the object 20 on which the magnetic labels 10 are being applied. The importance is the difference between the adhesion force of the adhesive of the magnetic label 10 being applied to the object 20 and the magnetic attraction between the magnetic label 10 and the transfer instrument 14, and this may be coined as relative connection values as well. Therefore, the adhesion value of the magnetic label 10 to the object 20 should be stronger than the connection force of the magnetic label 10 to the transfer instrument 14.

The method may be used in the following fields, activities, objects: Labelling of small vials, biomedical containers, small objects and devices, hard to label locations such as surfaces that located on the bottom of a well-like container, or have an indentation, or inside crevices, electronic boards and components, electronic devices, clean room applications, electrical equipment and wiring, automotive industries, avionics, instrumentation, gages, labelling procedure requiring a magnifying glass or a microscope, jewelry, optical and in any other type of industrial, research or field where an identification with labels and more especially with small labels are required or in environments where the application of labels manually may be inconvenient or not advised, such as bio-hazard environments, in the presence of toxic substances, high or low temperatures or cryogenic environments. As an embodiment, larger magnetic labels 10 can be used in other industries for labeling e.g. packages and boxes on a conveyor line or equipment. The rod or the instrument 14 can be customized to have a different shape or configuration to meet the requirements of the labelling application. The rod can be made of a wide variety of any types of materials including but not limited to materials that have a flexibility to twist and turn the rode under any angle or extend it to a desired length. In an embodiment, the instrument 14 consists of a material including but not limited to one or more of the following: a polymer, plastic, glass, metal, magnetic material, rubber, graphite, composite materials, wood, any combination thereof, etc. In an embodiment, the instrument 14 may be coated with some coatings or layers to make it more convenient or comfortable to handle for continued use. In an embodiment, the coating may be hypoallergenic. In another embodiment, the instrument 14 or the magnetic label 10 or any components thereof may have antimicrobial coating or other type of coatings facilitating their disinfection, cleaning or sterilization.

As the magnetic labels 10 may be used one at a time in the method described above by manipulation of the transfer instrument 14, the support liner(s) 12 may be provided with liner cuts or perforations, to expose one magnetic label 10 at a time, to define elongated strips of magnetic labels 10, or to allow sections of one magnetic label 10 and support liner(s)/backing sheet 12 to be separated from a remainder of a sheet. The combination of slits (a.k.a., cuts) and perforations allows stripping away the support liner 12 through the cut lines, and separating desired sections through the perforations while maintaining the structural integrity of the sheet. The cuts and the perforations of different layers including the support liners and the transfer label material itself can be in any direction or orientation. Furthermore, the cuts and perforations may have some angles, curved shaped configurations and twists or combinations thereof to facilitate the manipulations. It is also considered to emboss the support liner 12 to facilitate the peeling off of the magnetic labels 10. These are options among others.

The adhesion between the contact end surface 14A of the transfer instrument 14 and the magnetic labels 10 may be greater than between the magnetic labels 10 and the support liner 12 as the latter is designed with a view to allowing an easy release of the magnetic labels 10. It is therefore contemplated to have particular adherence properties for the magnetic labels 10, such as tackiness, loop-tack or peel adhesion, relative to the magnetic attraction, to ensure that the magnetic labels 10 connect on the contact end surface 14A of the transfer instrument 14 while being picked up, and for the magnetic labels 10 to transfer onto the object 20. Also, it is contemplated that the release level of the support liner 12, such as the release level of the silicone coating on the liner 12, be selected to ensure that the magnetic labels 10 can be released and connect on the contact end surface 14A of the transfer instrument 14 while being picked up, and for the magnetic labels 10 to transfer onto the object 20. The adhesive of the layer 10C of the magnetic label 10 can be of any type permitting or promoting the adhesion of the label 10 to a target surface. As a non-limitative examples it could be permanent, removable, repositionable adhesives based on any type of chemistry including but not limited to water-based, emulsion, acrylic, hot-melt, UV-hot-melt, rubber, silicone, latex, UV-curable, LED-UV curable, Electron-Beam curable (EB), any combination thereof, etc. In an embodiment, the adhesive of the layer 10C of the magnetic label 10 is cryogenic and can withstand −196C or below. In another embodiment, the adhesive is cryogenic and can withstand direct contact with liquid nitrogen. In another embodiment, the adhesive is cryogenic and can withstand −80C or below. In another embodiment, the adhesive can withstand contact with dry ice. In another embodiment, the adhesive can withstand a temperature of −65C or below. In another embodiment, the adhesive can withstand a temperature of −40C or below. In another embodiment, the adhesive can withstand a temperature of −20C or below. In another embodiment, the adhesive can withstand a temperature of +4C or below. By withstanding it is meant that the adhesive maintains suitable adhesive properties to adhere to the target surface and remains adhered during exposure to the referred temperatures/conditions. Moreover, in an embodiment, the adhesive of the layer 10C is capable of sticking to an already frozen surface at −70C or below. In an embodiment, the adhesive is capable of sticking to an already frozen surface at −40C or below. In an embodiment, the adhesive is capable of sticking to an already frozen surface at −20C or below. In an embodiment, the adhesive is capable of sticking to an already frozen surface at 0C or below. In an embodiment, the adhesive is capable of sticking to a cold surfaces at +4C or below. In an embodiment, the adhesive is capable of sticking to a cold surface at +12C or below. In an embodiment, the adhesive is capable of sticking to wet and/or frosty surface. Such adhesives may be available under the brand name Lab-Tag™, as used for labels referred to as deep-freeze labels, cryogenic labels, CryoSTUCK® labels, for example. In laboratories, biological samples, enzymes and compounds are often stored in refrigerators, low temperature freezers and Dewar vessels containing liquified gas such as liquid nitrogen (a.k.a., liquid nitrogen tanks). The Dewar is filled with liquid nitrogen and biological samples such as cells are stored inside vials which are placed in cryogenic boxes inside racks immersed inside the Dewar. There are other types of containers used for sample storage inside Dewars such as IVF straws, goblets, canisters, metal racks, plastic bags, etc. Some of the samples may come in direct contact with the liquid nitrogen and some may remain in the vapor phase of the nitrogen inside the tank. In some industries, other types of liquified gases can be used for cryogenic applications such as liquid helium at −269C, liquid oxygen at −183C, liquid hydrogen at −252C, liquified natural gas at −162C. The freezer types commonly used in laboratories can create temperatures −20C, −40C, −70C, −80C, −120C, −160C, etc. The above mentioned temperatures are approximate and each of the mentioned freezers can be set to higher or lower levels. Various types of containers are commonly used in refrigerators and freezers including but not limited to vials, tubes, ampules, bottles, metal racks, plates, petri dishes, cell culture plates, PCR tubes, boxes including freezer boxes, microscope slides, plastic bags, etc. The magnetic labels 10 are suited for uses in such applications, provided suitable adhesives are used as identified above. The magnetic labels 10 can be provided as a separate unit, as a refill to be used with the instrument 14, for instance in the form of sheets. The magnetic labels 10 as well as any components described in the present disclosure can be provided in a sterile condition, individually or as combined with other components such as the instrument 14, and/or the objects that will be labeled. All or some parts of a kit may be sterilized, or they can be provided as non-sterile that can be sterilized by the user.

The instrument 14 may have more than one tip on each end or on either end, it might have exchangeable tips for different shapes and/or dimensions, or it might have a rotational configuration allowing revolving of available tips. According to an embodiment, the magnetic labels 10 and/or the instrument 14 can be sterile or can be sterilised such as via autoclaving, gamma irradiation, ethylene oxide or any other method. In an embodiment, a kit is provided in a sterile condition, or that can be sterilised, the kit including the instrument 14, one or more magnetic labels 10 with or without the support liner 12. The kit may include an object such as container for the magnetic labels 10, all of which may be in a sterile condition or sterilisable. The term “kit” in the present disclosure may mean providing or rendering available for purchase the combination of the components together or providing or rendering available for purchase any of the components separately which can be put together and used by a end user. Each of the components should be considered as the part of the kit which is covered by the present disclosure.

In spite of the described use of the magnetic labels 10 for manual applications, the magnetic label 10 and instrument 14 can be used in automation devices for labeling objects and packages, for instance with the instrument 14 being part of automated equipment or of a robot. In this case the instrument 14 with a magnetic or magnetophilic tip can be connected to a device that will allow the instrument 14 to pick the labels 10 from the support liner 12 and apply to a surface. Such an automation device can be an add-on to a printer that can print-and-apply labels or it can just apply blank or printed labels. The instrument may be integrated or connected to another device a) mechanically, b) wirelessly or c) through wire. In case electro-magnetic force is used, the picking and releasing of the label 10 may be time-controlled to an electrical impulse to activate and deactivate the magnetic force to facilitate the labeling. In addition, a vacuum air suction device might be connected to the instrument 14 to facilitate the lifting of the labels 10 from the support release liner 12.

The magnetic labels 10 can be printed using various printing methods including but not limited to thermal-transfer, direct-thermal (ink incorporated on top or inside the facestock of the label and released upon heating from the printhead of the printer), laser, inkjet, LED-printer, UV-printer, impact printer or inscribed by a writing instrument such as a pen, pencil, permanent marker, or any other instrument that can dispose ink on a surface.

From a general perspective, the present disclosure pertains to a kit for labelling an object with a target label, the kit including at least the instrument 14 having at least one end for manipulating labels; one or more labels 10 releasably connectable to the end of the instrument 14 by a connection force A resulting from magnetic attraction, the connection force A between the magnetic force and the instrument being greater than an adhesion force B between a under surface of the label 10 and the support liner 12, the connection force A between the label and the instrument 14 being less than an adhesion force C between the under surface of the label 10 and a target object at the moment of adhesion of the label on the target object. For example, if the instrument 14 uses an electromagnet, at the moment of the adhesion, there may be little or no magnetic force between the label 10 and the electromagnet but before that, the force may be stronger or weaker than the adhesion force C. The instrument 14 and label 10 are used to transfer the label from the support liner 12 to a target object by releasable connection of the label 10 to the instrument 14.

The present disclosure may independently involve a method for labelling an object that may have one or more of: applying an instrument against a label on a support liner, a connection force A from magnetic attraction between the instrument and the label being greater than an adhesion force B between the label and the support liner; peeling the label from the support liner by distancing the instrument from the support liner with the label connected to the instrument; applying the end of the instrument with the label thereon against a target surface of the object, an adhesion force C between the label and the object being greater than said connection force A between the instrument and the label at the moment of adhesion of the label on the target object; and distancing the instrument from the object with the label adhering to the target surface of the object and detaching from the end of the instrument.

According to an embodiment, a method may include creating the magnetic or magnetophilic labels 10, in which an ink, varnish or a top-coat mixed with magnetophilic powder or particles (e.g., a metal) is applied onto the surface of the label material (e.g., substrate). The labels 10 may be cut or die-cut before or after applying the ink, varnish or top-coat, and which labels 10 may subsequently be used as described above.

If an electromagnet is used, then the label 10 may include metal or electromagnet attracted powder/particles that will be attracted to the instrument 14 through electro-magnetic force and then released to the target surface due to adhesive strength and lack of or reduced magnetic force, as the electromagnet may be switched off at the moment of the adhesion. As a result of the switching off, there may or may not be negligible magnetic forces on the instrument 14 at the placing of the label 10 on the target surface.

The magnetic label 10 can be used for other purposes such as studying magnetic effects in research, for example in biology, e.g., applying magnetic labels to petri dishes with cells or bacteria inside.

1. A kit for labelling an object with a target label comprising:
an instrument having at least one end for manipulating labels, and
at least one label adhered to a support liner on an under surface;
wherein the at least one label and the instrument have a magnetic connection force A resulting at least from magnetic attraction,
wherein the at least one label is releasably connectable to the end of the instrument by the connection force A, the connection force A between the label and the instrument being greater than an adhesion force B between said under surface of the label and the support liner, the connection force A between the label and the instrument being less than an adhesion force C between the under surface of the label and a target object at the moment of adhesion of the label on the target object;
whereby the instrument and label are used to transfer the label from the support liner to the target object by releasable connection of the label to the instrument.

2. The kit according to claim 1, including a plurality of the at least one label on the support liner.

3. The kit according to claim 1, wherein the at least one label is magnetophilic and the instrument includes a magnet.

4. The kit according to claim 3, wherein the at least one label has at least an adhesive layer and a facestock.

5. The kit according to claim 4, wherein the adhesive layer includes ferromagnetic particles.

6. The kit according to claim 3, wherein the facestock includes ferromagnetic particles.

7. The kit according to claim 3, further including one or more of a top coat, a varnish and an ink on the facestock.

8. The kit according to claim 7, wherein the top coat, the varnish and/or the ink on the facestock include ferromagnetic particles therein.

9. The kit according to claim 3, wherein the magnet in the instrument is a permanent magnet.

10. The kit according to claim 3, wherein the magnet in the instrument is an electromagnet.

11. The kit according to claim 10, including a switch on the instrument to actuate the electromagnet.

12. The kit according to claim 1, wherein the at least one label is magnetic and the instrument is magnetophilic.

13. The kit according to claim 12, wherein the at least one label has at least an adhesive layer and a facestock, the facestock including a flexible magnetic material.

14. The kit according to claim 1, further including at least one of the target object, the target object being a container.

15. The kit according to claim 14, wherein the target object is magnetic or magnetophilic.

16. The kit according to claim 1, wherein an adhesive is at the at least one end of the instrument and contributes to the connection force A.

17. The kit according to claim 16, wherein the adhesive at the at least one end is on a transfer label releasably adhered to the at least one end of the instrument.

18. The kit according to claim 1, wherein the instrument has two ends configured for manipulating objects.

19. The kit according to claim 1, wherein an adhesive of the under surface is an adhesive withstanding a temperature of −20C or below.

20.-26. (canceled)

27. The kit according to claim 1, wherein an adhesive of the under surface is an adhesive having frozen surface adherence capability at a surface temperature of 0C or below.

28.-57. (canceled)
